(19) United States
(12) Patent Application Publication
(10) Pub. No.: US 2004/0187049 A1
(43) Pub. Date: Sep. 23, 2004

(54) Very small pin count IC tester

(75) Inventor: Burnell G. West, Half Moon Bay, CA (US)

Correspondence Address: William L. Botjer, PO Box 478, Center Moriches, NY, 11934, US

(73) Assignee: NPTEST, INC., San Jose, CA

(21) Appl. No.: 10/376,025

(22) Filed: Feb. 27, 2003

(51) Int. Cl. G06K 5/04

(52) U.S. Cl. 714/699

(57) ABSTRACT

The present invention provides a method and system for testing a semiconductor device under test (DUT), such as an IC, with the help of a tester. A clock generator in the tester generates a clock signal that is sent over to the DUT on a clock signal line. Prior to an actual test, transmission and reception of data between the tester and the DUT, is synchronized with the clock signals. The invention utilizes simultaneous bi-directional signaling (SBS) for simultaneously transmitting and receiving test related data between the tester and the DUT over a single transmission line. The DUT replies with response signals corresponding to these test related data over the same transmission line. The use of SBS reduces the time required for the test, the number of pins and hence, overall cost and complexity of the testing process involved with the test.

### BACKGROUND

The present invention relates to the field of electrical integrated circuits (ICs). More specifically it relates to the field of IC testing.

Over the last few decades, ICs have revolutionized the world of electronics and consumer goods. IC technology has played an important role in achieving miniaturization of large electronic devices, increasing their reliability and lowering the overall cost. ICs are now commonly used in almost all electronic systems today. Computers, mobile phones, radio, digital audio systems, digital watches and innumerable other devices might not have existed, if it had not been for ICs.

An IC is essentially a single piece of semiconductor material that has all circuitry built in it. As of today, a single IC can host millions of transistors and similar components. Fabricating millions of transistors in a small piece of semiconductor material is a task that requires utmost precision. To acquire utmost precision, the ICs need to be tested vigorously for performance. Since ICs form the backbone of all the operations in electronic devices, their performance has to be free from any error. A small error in the IC operation can be detrimental to the performance of the electronic device that employs it. Hence, it is very important to test ICs before they are put into use in electronic devices.

Specific devices, referred to as IC testers, have been developed for the purpose of testing ICs. Some examples of commercially available IC testers are the ITS 9000 series of IC testers from NPTest Inc. IC testers have acquired paramount importance because of heavy dependence on ICs for critical operations.

The testing of an IC involves generation of test signals and inputting them to the IC being tested. The output from the IC is compared with an already known correct output corresponding to the test signals. The IC testers carry out the process of generation of test signals and comparison of output of the IC with the known correct output. The IC is said to have passed the test only if it provides an output that is same as the known correct output or if the output is within an acceptable range of the known correct output. Some ICs are fabricated as amalgamations of different cores. Each core is a re-designed model of a complex function that can be used for a variety of purposes. Each core can be tested individually, and verification of the interconnections between different cores and other circuitry completes the testing of the whole IC.

In another method of testing of ICs, the testing mechanism, as a functionality of the system, is included in the IC. This is termed Built-in Self Test (BIST). BIST is a self-test mechanism in which the generation of test signals and the comparison of output are done by hardware existing on the chip. A combination of external IC testers and BIST engines is an effective technique for IC testing.

There are three main issues that need to be considered while designing external IC testers. First, the time required for the test should be minimized. Reduction of the time required for the test is particularly important where the number of ICs to be tested is very large. The transmission of signals between a tester and the device under test (DUT) should be very fast in order to minimize the time required for the test. However this is not easy to realize due to the noisy environment of the transmission line. Such noise can be picked up by a signal passing over the transmission line at great speed, thus degrading the quality of the signal. Consequently, with an increase in the speed of transfer, the reliability of the data transfer goes down. Such faulty transmission can cause good ICs to appear faulty, which lowers the total yield at the manufacturing stage. Thus, the design should find an optimum balance between signal speed and signal quality.

A second issue regarding the design of IC testers concerns the circuit overhead of the DUT. IC testers, which rely on BIST engines or which require additional functionality in the DUT, add an extra circuit in the DUT, thus increasing circuit overhead of the DUT. The requirement for additional circuitry in the DUT increases the design complexity and power requirements of the DUT, and requires an additional circuit area on the DUT chip. This increases the overall cost of the DUT chip. Therefore, the circuit overhead of DUT should be minimized to reduce the cost of testing.

Finally, the number of pins required for the test should also be minimized. The higher the number of pins, the greater is the fixturing complexity for testing. Fixturing involves connecting various pins of the tester to appropriate pins of the IC to be tested. This can involve thousands of pins during a testing process. Also, with a lesser number of pins, the number of ICs that can be concurrently tested is greater. This reduces the overall test cost per IC. Hence it is important to reduce the pin count in order to reduce the fixturing complexity (and thus, reduce the overall cost and time of the testing process).

There have been attempts in the existing art to address the above three issues. Some of the patents that address the above mentioned issues are discussed below.

Method of operation of an IC tester has been described in U.S. Pat. No. 4,523,312 titled “IC Tester”. This patent provides an IC tester for generating and stably delivering test signals. The IC tester sends test signals to the device being tested and receives corresponding outputs. It then compares the outputs with a known correct output to ascertain the quality of the device being tested. In this invention, the test signals are passed through low-pass filters to the terminals of the IC under test. This corrects the differences in the relative timings of test signals. Though this invention minimizes the relative differences between the test signals, it does not discuss the minimization of overall test time.

Scan based testing is another method of IC testing. Quite a lot of modern ICs have scan-based designs. Scan based testing is a design technique wherein sequential elements in an IC can be used to scan data into a portion of the IC and to scan the results out. Designers include a shift-register latch within a Boundary Scan Cell (BSC) adjacent to each I/O pin, permitting serialization of data into and out of the device and allowing a tester to control and observe device behavior using scan-test principles. The Scan cells for all device pins connect to form a chain, termed a “scan chain”, around the core to be tested. U.S. Pat. No. 6,418,545, titled “System And Method To Reduce Scan Test Pins On An Integrated Circuit”, describes a scan test method. The system and method of this patent facilitates utilization of a pin to communicate signals associated with scan test operations in different scan chains. This method makes use of the IEEE 1149.1 standard. In one embodiment of this invention, a controller is adapted to receive a single set of scan test signals via a set of scan test pins and provide multiple sets of scan operation signals to a plurality of scan chains. In another embodiment of this invention, a single set of scan test pins are utilized to provide dedicated communication of scan test signals to more than one scan chain. This invention reduces the number of pins used in the test, thereby leading to better fixturing. But the time required for a test is not reduced.

Often, an IC must be tested for speed, requiring that the clock speed be set at a value related to the speed test requirement. For example, in case of scan testing, the clock might be used not only for the scan chain input and output but also for the device activity, or it might be multiplied by an internal circuit on the device to a required speed. Therefore the clock frequency may need to be set at different values to satisfy these testing requirements.

Many of the existing techniques in the field of IC testing do not address all the issues associated with IC testing. The total time taken for testing of an IC is quite large in some cases, though fixturing is not too complex. The testing mechanism adds to the circuit overhead of the DUT itself in order to minimize test time. Techniques relying totally on BIST engines increase the fabrication complexity of the ICs. Fixturing of the testing device becomes complex with an increase in the number of signal detectors and signal generators. More detectors and generators add to the number of pins on the tester. Also with increase in the number of lines carrying test signals the path skew is difficult to minimize. Most of the IC testers used currently, use many different paths for sending and receiving test related data. The number of paths carrying test signals is large in this case. In case of testers using same line for sending and receiving test related data, timing difficulties are aggravated. Once the tester sends data, the tester's driver has to be disabled in order to avoid interference with the data being received. Thus, the functions (of sending and receiving data) do not happen simultaneously, and the tester has to wait for the whole of the turnaround time.

From the above mentioned discussion, it is clear that there is need of an IC tester that minimizes the total test time, leading to testing of larger number of ICs in a lesser time. The tester should not pose any timing difficulties as regards to sending and receiving test related data. Also, the tester should not greatly increase the circuit overhead of the IC under test. The tester should have minimum possible pin count to reduce the fixturing complexity while enabling testing of many ICs concurrently, therefore reducing the overall cost of the testing process per IC.

### SUMMARY

It is an object of the current invention to provide a testing mechanism that minimizes the time taken for testing the performance of Integrated Circuits (ICs).

It is another object of the current invention to minimize the circuit overhead in a device under test (DUT) during the testing process.

It is yet another object of the current invention to reduce the number of pins of the DUT, used in the testing mechanism.

In order to achieve the above-mentioned objectives the invention proposes a method and system for testing a semiconductor device such as an IC with the help of a tester. The tester comprises a test circuit and a clock generator. The clock generator generates the clock signals. A transmission line, called clock line, is connected between the tester and the DUT to carry clock signals from the tester to the DUT. Another transmission line, called I/O line, is connected between the tester and the DUT to carry the test related data between the tester and the DUT. Prior to an actual test, the transmission and reception of data between the tester and the DUT is synchronized with the clock signals generated by the clock generator. Thereafter, the test related data is sent and received simultaneously over the I/O line between the tester and the semiconductor device. The tester further comprises a transceiver, capable of simultaneously transmitting and receiving test related data over the I/O line. The semiconductor device also comprises a similar transceiver capable of simultaneously transmitting and receiving test related data over the I/O line.

The invention uses simultaneous bi-directional signaling (SBS) to combine input to the DUT and output from the DUT on a single line. The use of SBS allows a single line to be used simultaneously for both input and output for the DUT. Hence, the time required for the test as well as the number of pins involved with the test are reduced.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 shows a block diagram of the environment of the invention;

FIG. 2 illustrates the essential elements of tester and device under test (DUT);

FIG. 3a shows the circuitry required for simultaneous bi-directional signaling (SBS);

FIG. 3b shows a table of values of voltages at various points in the SBS circuitry during operation;

FIG. 3c shows the timing diagram of voltages during an SBS operation;

FIG. 4 shows a flow chart that illustrates a preparation test sequence to synchronize the DUT and the tester;

FIG. 5 shows a flow chart that illustrates the test sequence for a test data packet;

FIG. 6a shows the timing relationship of the signals when the tester is transmitting the test data and the clock;

FIG. 6b shows the timing relationship of the signals when the DUT is receiving the test data and the clock;

FIG. 6c shows the block diagram of the tester and the DUT with the data and the clock traveling in same direction from the tester to the DUT;

FIG. 7a shows the timing diagram of DUT transmitting at falling edge of the clock;

FIG. 7b shows the timing diagram of the tester receiving data;

FIG. 7c shows a block diagram of the tester and the DUT with the data and the clock traveling in the opposite direction;

FIG. 8a shows an arrangement of buffers;

FIG. 8b shows the timing diagram of outputs of each of the buffers;

FIG. 8c shows a block diagram of construction of a buffer; and

FIG. 9 shows an alternative embodiment of the invention, wherein a clock line is shared between multiple DUTs.

### DESCRIPTION OF PREFERRED EMBODIMENTS

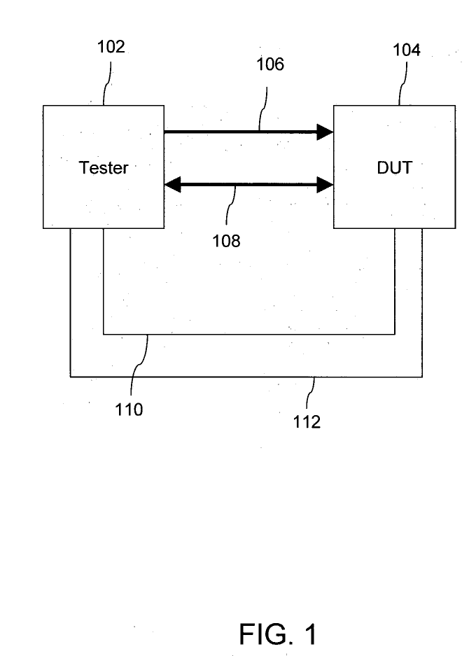

The present invention provides a system and method for testing of a semiconductor device such as an integrated circuit (IC). FIG. 1 shows a device under test (DUT) 104 being tested by a tester 102 by passing clock signals and test related data over two transmission lines 106 and 108. The clock signals are passed from tester 102 to DUT 104 over first transmission line 106, hereinafter referred to as clock line 106. The test related data is exchanged between tester 102 and DUT 104 over second transmission line 108, hereinafter referred to as input/output (I/O) line 108. For the purpose of testing, tester 102 sends test signals to DUT 104 over I/O line 108. DUT 104 then sends output corresponding to the test signals back to tester 102. Tester 102 compares the output of DUT 104 with a known correct output to evaluate the performance of DUT 104.

The present invention utilizes I/O line 108 for simultaneously sending and receiving the test related data (i.e. sending test data from tester 102 to DUT 104, and receiving output data from DUT 104 at tester 102). The simultaneous sending and receiving of data on I/O line 108 is achieved by simultaneous bi-directional signaling (SBS) technique. Tester 102 synchronizes DUT 104 with the clock signals (being sent over clock line 106) prior to the test. It is only after synchronization that actual transmission of test data is undertaken. FIG. 1 also shows power lines 110 and 112, through which tester 102 satisfies power requirements of DUT 104. In one embodiment of the current invention, power line 110 and power line 112 correspond to VDD and VSS respectively. VDD and VSS are terms of art related to specific power requirements of CMOS circuits.

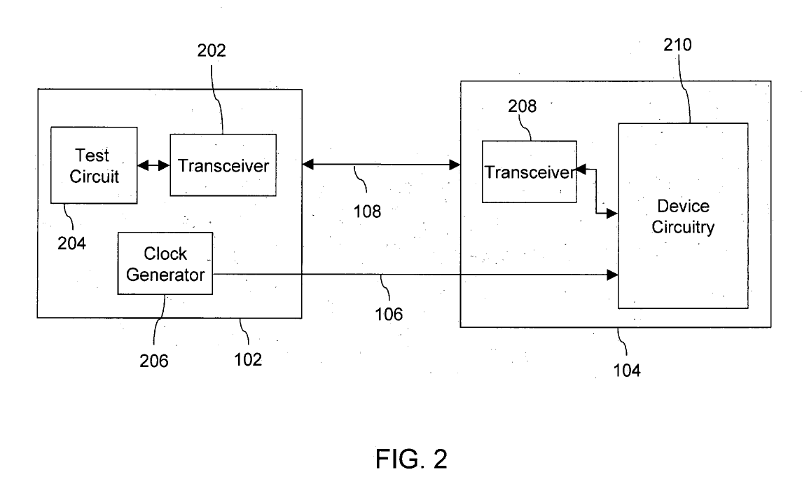

FIG. 2 illustrates the essential elements of tester 102 and DUT 104. Tester 102 comprises a transceiver 202, a test circuitry 204, and a clock generator 206. Clock generator 206 sends clock signals to DUT 104 through clock line 106. Transceiver 202 sends and receives data through I/O line 108. DUT 104 comprises a transceiver 208 and a device circuitry 210. Transceiver 208 sends and receives data through I/O line 108. Device circuitry 210 gets clock signals through clock line 106.

The invention utilizes simultaneous bi-directional signaling (SBS) for combining input and output on I/O line 108. Use of SBS enables simultaneous sending and receiving of data over the I/O line 108. The technique of SBS is known in the art. For the purpose of the current invention, an exemplary embodiment of SBS is described below. It should, however, be apparent to one skilled in the art that other variants of SBS such as the ones mentioned in U.S. Pat. No. 4,698,800, titled “Bi-directional Transceiver Circuit”, and U.S. Pat. No. 5,216,667, titled “Simultaneous Bi-directional Transceiver”, can also be used without deviating from the spirit and scope of the invention.

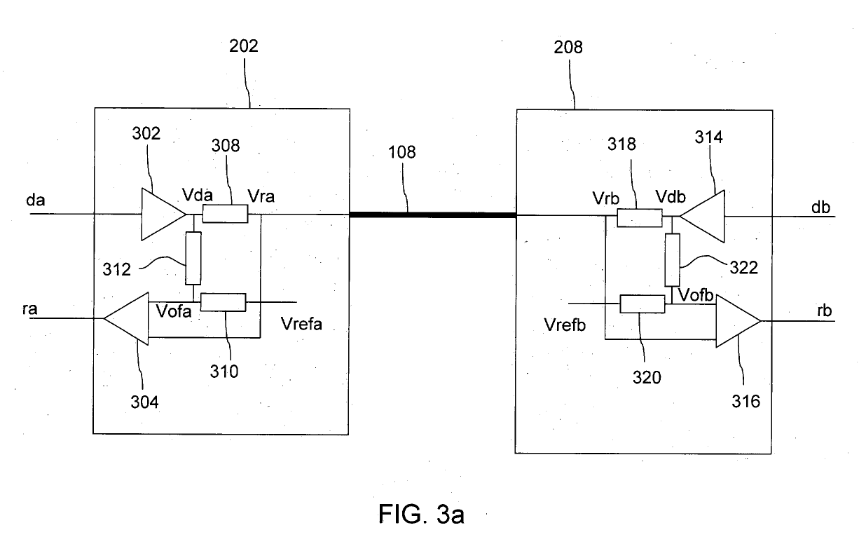

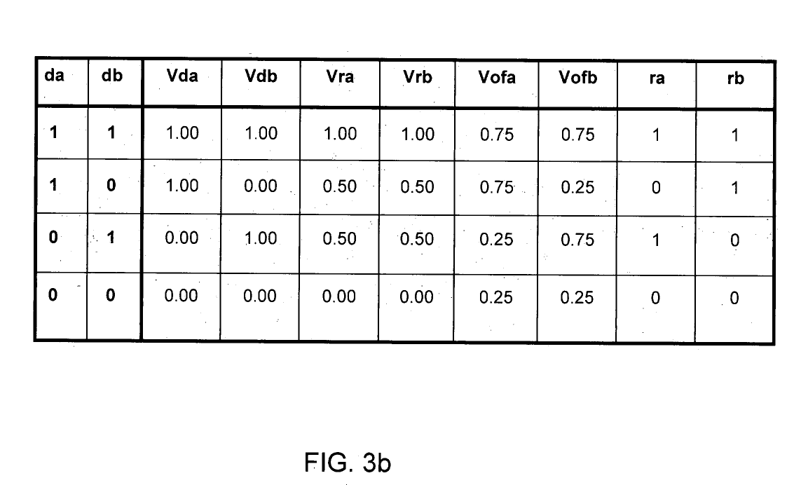

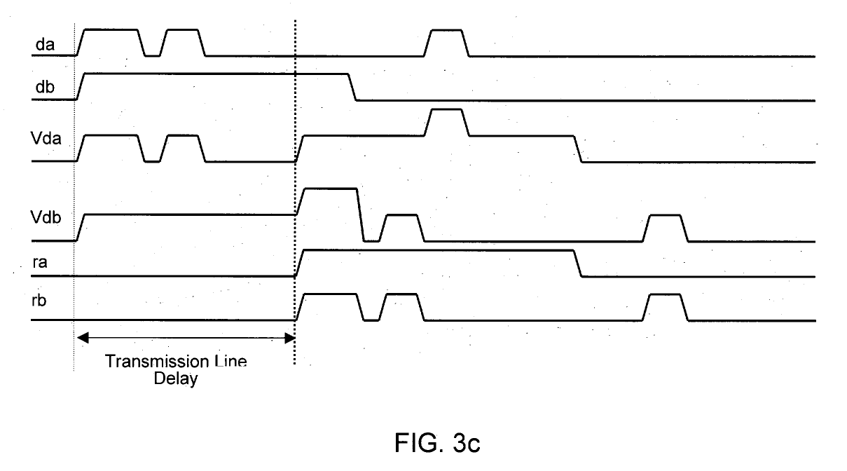

FIG. 3a shows the circuitry required for SBS. SBS is used on I/O line 108 that connects transceiver 202 and transceiver 208. Transceiver 202 comprises a conventional driver 302, a comparator 304 and a resistance network. In the preferred embodiment of the invention driver 302 is a push-pull driver because of its desirable efficient power characteristics. Additional details about the driver 302 can be found in U.S. Pat. No. 5,216,667, titled “Simultaneous Bidirectional Transceiver”. The resistance network further comprises a resistor 308, a resistor 310 and a resistor 312. Resistor 308 is used to match the line impedance of I/O line 108. Comparator 304 is used as a receiver. Transceiver 208 in DUT 104 comprises a driver 314, a comparator 316 and a resistance network comprising a resistor 318, a resistor 320 and a resistor 322. Resistor 318 matches the line impedance of I/O line 108. Comparator 316 is used as receiver for receiving signals from DUT 104. The whole circuitry together achieves simultaneous transfer of voltage levels from one end to another by coupling tester 102 to DUT 104.

For application of the SBS technique, driver 302 of tester 102 has to drive the voltage level corresponding to logic state da over I/O line 108 such that the logic state rb at the output of comparator 316 is same as that of da. Similarly driver 314 has to drive the voltage level corresponding to logic state db over I/O line 108 such that logic state ra is same as that of db. Voltage Vda is the voltage at the output of driver 302. Voltage Vdb is the voltage at the output of driver 314. Vda and Vdb are available to I/O line 108 simultaneously. Vra is the voltage at the point where transceiver 202 is coupled to I/O line 108. Vrb is the voltage at the point where transceiver 208 is coupled to I/O line 108. Accordingly, the task for the transceivers is to separate the signal being driven by the transceiver from the signal being received. The resistor network separates the combined signals at the point where transceiver 202 or transceiver 208 is coupled to I/O line 108. The settling time of the resistor network is kept very small, typically less than 0.1 nanoseconds. This helps in separating the signal from driver and the signal from the receiver leading to a higher bi-directional data rate.

A voltage Vrefa is generated in transceiver 202. Resistor 312 and resistor 310 are equal to each other, and so provide a voltage value Vofa offset from Vrefa setting by half the difference between Vrefa and Vda. Similarly, a voltage Vrefb is generated in transceiver 208. Resistor 320 and resistor 322 are equal to each other, and so provide a voltage value Vofb offset from Vrefb setting by half the difference between Vrefb and Vdb. Comparator 304 compares Vra and Vofa and returns logic state ‘one’ voltage level if Vra is greater than Vofa. Thus ra has logic state ‘one’ if Vra is greater than Vofa, and logic state ‘zero’ otherwise. Comparator 316 compares Voltage level Vrb and Vofb and returns logic state ‘one’ voltage level if Vrb is greater than Vofb. Thus rb has logic state ‘one’ state if Vrb is greater than Vofb, and logic state ‘zero’ otherwise. FIG. 3b shows a table that has the values of various voltages during SBS. In the table a logic family has been assumed that has HIGH voltage level of one volt and LOW voltage level of zero volts. The table shows the values of various voltage levels for all possible logic state combinations of da and db. The different voltage levels that might occur at Vra and Vrb, corresponding to the four different logic states variables da and db, can be calculated from the following equations:

Vra(11)=Vrb(11)=1/2(VHIGHa+VHIGHb)

Vra(10)=Vrb(10)=1/2(VHIGHa+VLOWb)

Vra(01)=Vrb(01)=1/2(VLOWa+VHIGHb)

Vra(00)=Vrb(00)=1/2(VLOWa+VLOWb)

Each voltage is expressed as a function of two variables da and db. VHIGHa and VLOWa are voltages corresponding to logic state ‘one’ and logic state ‘zero’ correspondingly for transceiver 202. VHIGHb and VLOWb are voltages corresponding to logic state ‘one’ and logic state ‘zero’ correspondingly for transceiver 208. The above equations are based on the assumption that resistors 308 and 318 are the same size, and the series resistance of the transmission line is small enough to be neglected as compared to resistors 308 and 318.

FIG. 3c indicates the timing of driven and received signals for the given SBS circuit. The waveform da generated by driver 302 of transceiver 202 is reproduced as waveform rb at output of comparator 316 of transceiver 208, after the delay in time caused by the length of I/O line 108. Similarly, waveform db generated by driver 314 of transceiver 208 is reproduced as waveform ra at output of comparator 304 of transceiver 202, after the delay in time caused by the length of I/O line 108. Thus, signals are transmitted and received simultaneously by transceiver 202 and transceiver 208. Simultaneous bi-directional signaling is thus achieved.

Having explained the environment of the invention and the SBS technique, the steps involved in testing are now described in detail.

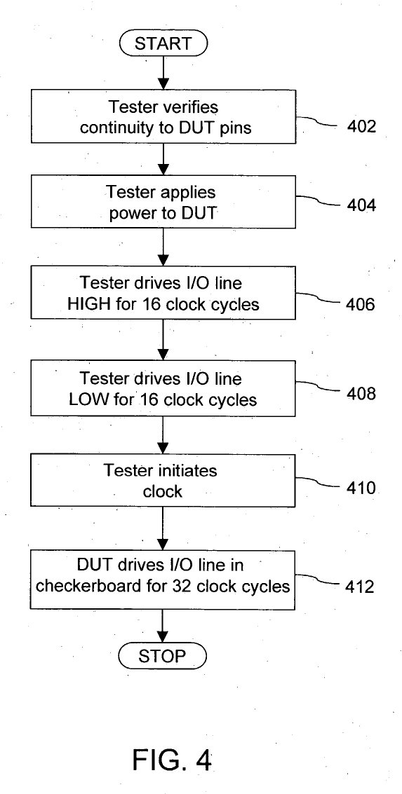

To start testing DUT 104, I/O line 108 and Clock line 106 are physically connected to appropriate pins of DUT 104 and tester 102. Prior to the start of an actual test procedure, tester 102 establishes an ability to communicate with DUT 104. A preparation test sequence is followed in order to synchronize DUT 104 with respect to the clock signal sent over clock line 106 by tester 102. The preparation test sequence also synchronizes the transmission of test related data from the tester 102 to the DUT 104 with the clock, and also the reception of test related data by the tester with the clock signals. DUT 104 needs to be synchronized to the clock signal, as DUT 104 does not generate the clock and all the operations should take place in synchronization with the clock. The clock frequency must be set according to the test requirement for the device. FIG. 4 shows a flow chart that illustrates this sequence. First, tester 102 verifies continuity to pins of DUT 104 that are connected to clock line 106 and I/O line 108, as shown in step 402. Tester 102 then applies power to DUT 104, as shown in step 404. At this time, the clock remains inactive and the power to DUT transceiver 208 remains in the low state. At step 406, tester 102 drives I/O line 108 HIGH for 16 clock cycles. The term HIGH refers to the voltage level corresponding to the logic state ‘one’, and the term LOW refers to the voltage level corresponding to logic state ‘zero’. The output of DUT transceiver remains LOW throughout step 406. Tester 102 then drives I/O LOW for 16 clock cycles as shown in 408.

Step 406 and step 408 are undertaken in order to check that proper voltage levels are received and transmitted over I/O line 108. It should be obvious to one skilled in the art that the number of clock cycles mentioned in step 406 and step 408 is not limited to 16 clock cycles. Step 406 and step 408 can be carried out for other numbers of clock cycles as well. But they are carried out for 16 clock cycles, because it is convenient and easy to implement steps 406 and 408 for 16 clock cycles with very little circuitry required. Tester 102 then initiates clock to DUT, as shown in step 410. After initiation of clock, DUT 104 drives I/O line 108 in a “checkerboard” for 32 clock cycles, as shown in step 412. This means that DUT 104 drives I/O line 108 HIGH and LOW alternatively for 32 clock cycles. Step 412 is undertaken in order to establish the best time for receipt of a signal at comparator 304 of tester 102. The checkerboard provides a timing alignment pattern for tester 102. After tester 102 establishes best time for data receipt, tester 102 proceeds with sequence of test data packets for actual test of DUT 104. It should be obvious to one skilled in the art that number of clock cycles mentioned in step 412 is not limited to 32. Same step can be carried out for more or less than 32 clock cycles with desired effect. Step 412 is carried out for 32 clock cycles, as it is convenient and easy to implement the process for 32 clock cycles with very little circuitry required.

Once the timing alignment pattern between tester 102 and DUT 104 is set up, data may be transmitted back and forth between the devices over I/O line 108 through the use of SBS. Tester 102 sends test data to DUT 104 in packets. A test data packet consists of a stream of bits, which incorporates test data word count, test data word stream and cyclic redundancy check (CRC). In preferred embodiment of the invention, a test data packet consists of a number of 16 bit words. Transmission of signals over I/O line 108 is undertaken by the transceivers on either side of I/O line 108. Transceivers 202 and 208 essentially separate the signal that they are driving from the signal they are supposed to receive. The signals driven by transceivers 202 and 208″ have higher amplitude than the signals received because the received signals travel over I/O line 108 and are attenuated by their path. The received signals also pick up noise on their way from one transceiver to another. Hence, transceivers 202 and 208 should be robust enough to keep the data signals away from the power line noise.

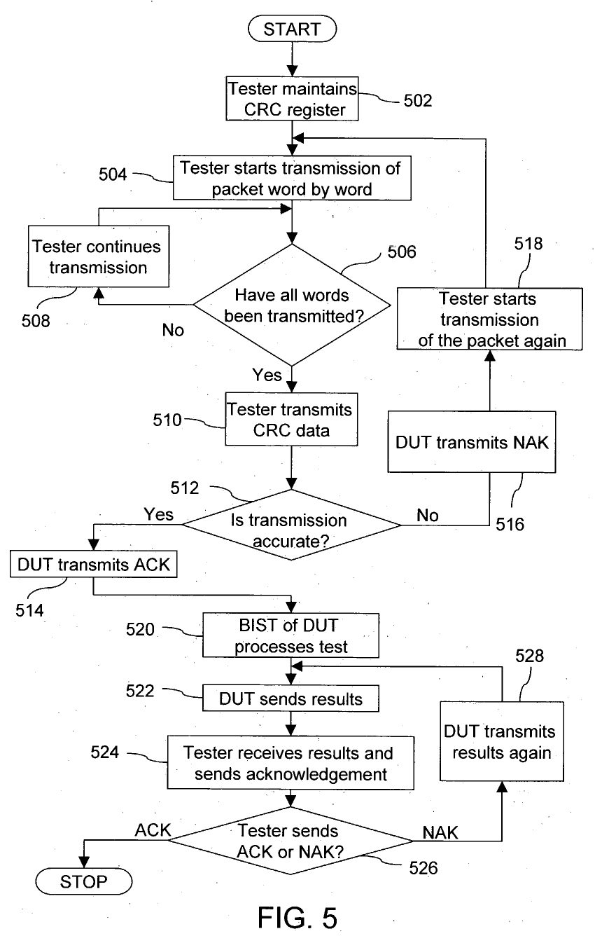

FIG. 5 shows a flow chart that illustrates the testing procedure with respect to transmission of one test data packet. Transceivers 202 and 208 maintain the Cyclic Redundancy Check (CRC) word as shown in step 502. CRC is done in order to detect errors during transmission. A CRC register includes the test data word count number and all of the data words transmitted. Test data can comprise many test data packets. Transceivers 202 and 208 on both sides of I/O line 108 support multiple packet transmissions. There are at least two clock cycles between end of a packet and start of next packet. During these two clock cycles, the transceiver that is transmitting data sends logic state ‘zero’. The packet starts with two cycles of logic state ‘one’, followed by a fourteen-bit number which is anywhere from 0 to 16383. If the number is 0, then one data word containing 16 data bits is transmitted. The test commences with transceiver 202 transmitting a packet word by word, as shown in step 504. The number of data words transmitted is checked periodically during packet transmission, as shown in step 506. If all data words are not transmitted, then the transmission is continued, as shown in step 508. Immediately after the last data word is transmitted, transceiver 202 transmits the CRC data, as shown in step 510. DUT 104 checks whether the transmission is accurate or not, as shown in step 512. DUT 104 acknowledges accuracy of transmission by sending response data to tester 102. Response data sent by DUT 104 comprises acknowledgement packets. DUT 104 acknowledges a proper receipt of the test data packet by sending an ACK packet, as shown in step 514. The bit stream of an ACK data word is 0000111100001111. If the packet transmitted is not received or if there is fault in the transmission, then DUT 104 sends an NAK packet, as shown in step 516: Bit stream of an NAK data word is 1111000011110000. In alternative embodiments, other bit values may be used for ACK and NAK packets.

In case an NAK packet is received, the transceiver retransmits the same packet, as shown in step 518. In different embodiments, neither, either, or both transceivers 202 and 208 support such packet retransmissions when needed, because support of packet retransmission requires more circuitry in the DUT. The actual number of data words transmitted is one greater than the fourteen-bit number that was transmitted at the beginning. The entire packet is acknowledged with an ACK or an NAK unless the received packet is itself an ACK or an NAK packet. Transceiver 202 does not send a packet until its last previous packet transmission has been acknowledged. After receiving a test data packet, DUT 104 provides the test data to its Built-in self-test (BIST) engine. The DUT BIST engine processes the test on device circuitry 210 of DUT 104, as shown in step 520. It gets the results of the tests from device circuitry 210. The BIST engine then decides when to send the response data containing the results to tester 102. Transceiver 208 then transmits the response data containing the results to tester 102 as shown in step 522. Results are transmitted as output packets. The output packets are used to evaluate the performance of DUT 104. Tester 102 receives the results when they arrive, as shown in step 524. On reception of the results, tester 102 sends an ACK packet or an NAK packet to DUT 104, as shown in step 526. An ACK packet is sent if the transmission of the results is faultless. If there are any errors in the transmission, then transceiver 202 of tester 102 transmits an NAK packet. If an NAK packet is sent, then DUT 104 has to re-transmit all the results to tester 102, as shown in step 528.

If the total amount of data to be transmitted to setup or to respond to any given test execution exceeds 16386 words, then the information is broken into several packets. Since any packet may be transmitted incorrectly, a packet is kept buffered until that packet has been acknowledged. This supports packet re-transmission when it is needed. If both devices are engaged in sending and receiving simultaneously, then it can happen that one packet moving in one direction is completed, while the other packet is still being sent in the other direction. In this case, the ACK or the NAK packet that must be generated in response to the completed packet is delayed until the packet currently being transmitted is completed. The transceiver, which has completed its transmission, holds the packet it just sent in its buffer until the packet it is receiving is completed. It also holds the packet in the buffer till the ACK or the NAK packet corresponding to the packet just sent is received as well. Since the packet it was receiving is now completed, it generates an ACK or NAK packet and as a consequence, the two ACK/NAK packets can be transmitted at almost the same time.

It may be noted that in an alternative embodiment of the current invention, other known methods for synchronizing transmissions or for transmitting and receiving test data packets can also be used without deviating from the spirit and scope of the invention.

For effective testing, the system must satisfy certain line impedance requirements. Firstly, I/O line impedance must be controlled. In a specific embodiment discussed above, if the chosen path impedance is 50 ohms, then the I/O line impedance can vary between 47 ohms and 53 ohms (i.e. ±6% of path impedance). The source impedance of tester 102 is kept within 6% of I/O line impedance. Hence in the specific embodiment, source impedance of tester 102 is chosen between 47 ohms and 53 ohms. Similarly, output impedance of DUT 104 is kept within 20% of I/O line impedance. The I/O line itself attenuates a transmitted signal. This reduces the amplitude of the signal at both transceiver inputs. In the embodiment, the signal attenuation is kept lower than 3 db in order to provide adequate noise margin. Thereby, the signal is protected from any noise.

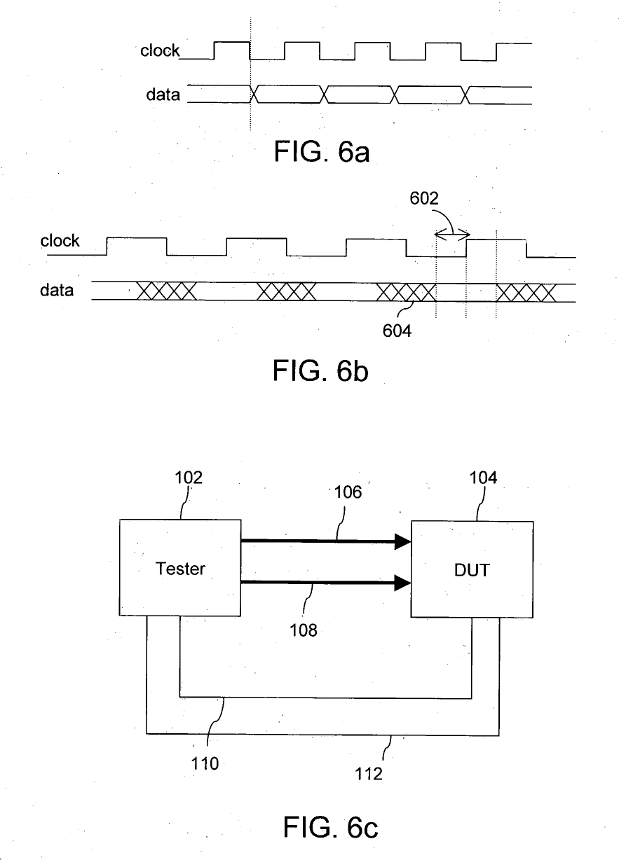

FIG. 6a shows the timing relationship of the signals when tester 102 is transmitting the test data and the clock signal. Since tester 102 is capable of establishing data transmission time and clock time to high precision, adjustments necessary for reliable transmission are possible. Tester 102 transmits data on falling edge of the clock. When tester 102 transmits data to DUT 104, the clock signals and the data on I/O line 108 travel in the same direction as shown in FIG. 6c. This brings up the issue of path skew between the two transmission lines. The delay caused by clock line 106 differs from the delay caused by I/O line 108. Since in some embodiments, tester 102 can adequately measure path skew, tester 102 can transmit clock and data at times required to satisfy device setup and hold time requirements. In other embodiments, fixture design can control path length to minimize skew in order to control relative arrival time of clock and data. Hence, as shown in FIG. 6.b, DUT 104 receives the transmitted data after expiry of setup time 602 on the rising edge of the clock. Setup time 602 is the time interval between the time of arrival of data and rising edge of the clock. DUT 104 allows setup time 602 to expire so that on the rising edge of the clock the input to the device is not changing. FIG. 6.b shows an ambiguity 604 in the time of changing state of the signal that in being received by DUT 104. Ambiguity 604 is due to the path skew between clock line 106 and I/O line 108. Tester 102 controls the timing of both the clock and the signal to DUT 104. If the path skew is maintained at acceptable levels, tester 102 does not have to control the reception of data by DUT 104 by adjusting the relative timing.

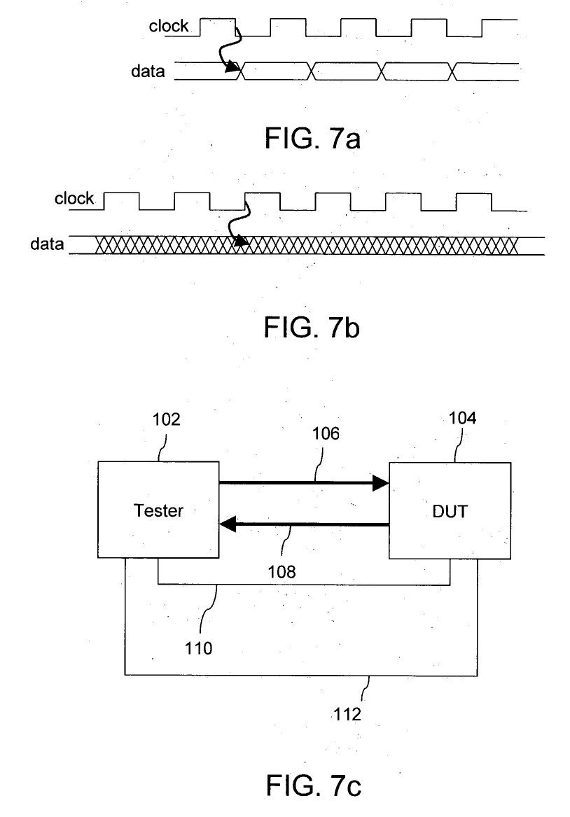

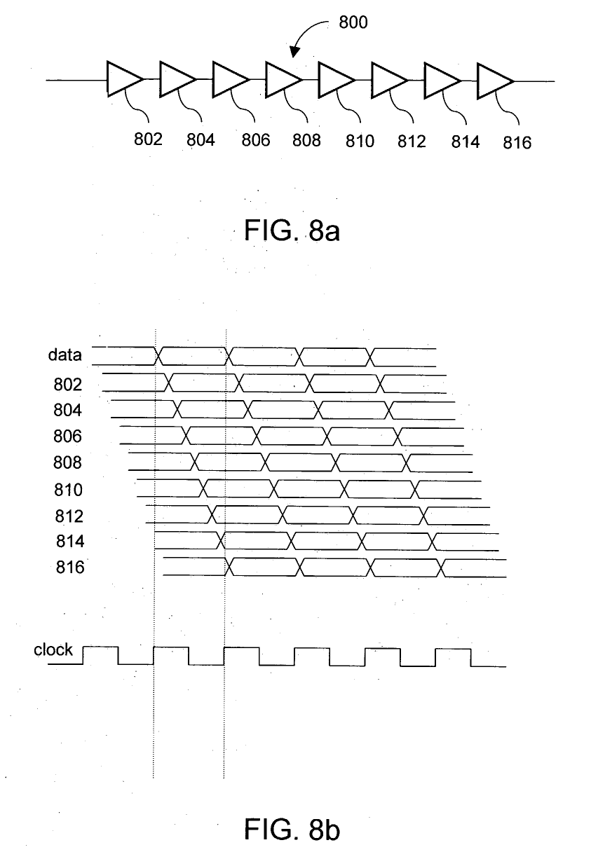

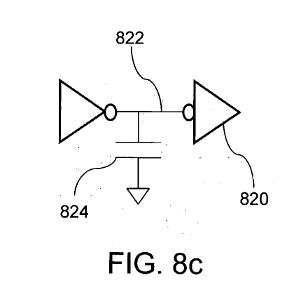

FIG. 7a shows the timing diagram of DUT 104 transmitting at falling edge of the clock. FIG. 7b deals with reception of the response data by tester 102. FIG. 7c shows the system details when the response data is transmitted from DUT 104 to tester 102. Tester 102 is enabled to receive data on the rising edge of the clock. There is no particular time when the response data arrives at tester 102, but it is known that the tester and DUT transceivers can be constructed so that the time delay between the tester and the DUT do not vary unacceptably during the test. However, tester 102 must strobe the signal carrying the response data when the signal is stable. But the response data may not remain stable at or very near the clock rising edge time. This problem is solved by adding a series of delay buffers to receiver of tester transceiver 202. FIG. 8a shows an arrangement of delay buffers 800 forming a response data receive timing alignment circuit. Arrangement of delay buffers 800 comprises delay buffer 802, delay buffer 804 and so on. FIG. 8b shows an example of the timing diagram of outputs at the end of each delay buffer of arrangement of delay buffers 800. These buffers are implemented by coupling a CMOS inverter 820 with another CMOS inverter 820 using a line 822 and a capacitor 824 as shown in FIG. 8c. It should be obvious to one skilled in the art that there are many techniques to implement such delay buffers.

In the specific embodiment of the invention, the fastest clock is expected to be 125 MHz. Hence its minimum period is 8 ns. Each of the buffers in the chain is slow, imposing a 1 ns delay on the signal as shown in FIG. 8b. Data is to be received on the rising edge of the clock. Hence for the purpose of reception of data it is determined which of the buffers 800 are going to be stable at that time. The signal at the input is difficult to recover, as shown in the example in FIG. 8b, because the data change is coincident with the rising edge of the clock. Hence the signal is buffered a little bit. A circuitry is incorporated to identify when the outputs of four successive buffers are identical, and which of the outputs are the two in the center of this set of four, during the initialization phase of the operation 412 of FIG. 4. The falling edge of the clock registers the output of these two buffers in a pair of D-type flipflops. During the data transmission phase of the operation, this particular pair of flipflops is always looked at. The data value recorded by these two flipflops accurately reflects the data transmitted during the now pre-aligned clock phase. Either of these flipflops contains the correct data bit; if they do not contain the same data then the transmission is unreliable. In this case, tester 102 is prepared to send a NAK response when the packet is completed. In FIG. 8b, it is clear that the first falling edge of the clock, it is difficult to strobe the data. At the next falling edge, outputs of buffer 804, buffer 806, buffer 808 and buffer 810 are identical. Of these buffers, buffer 806 and buffer 808 are central in location. Data at the output of buffer 806 and buffer 808 are registered in a pair of D-type flip-flops.

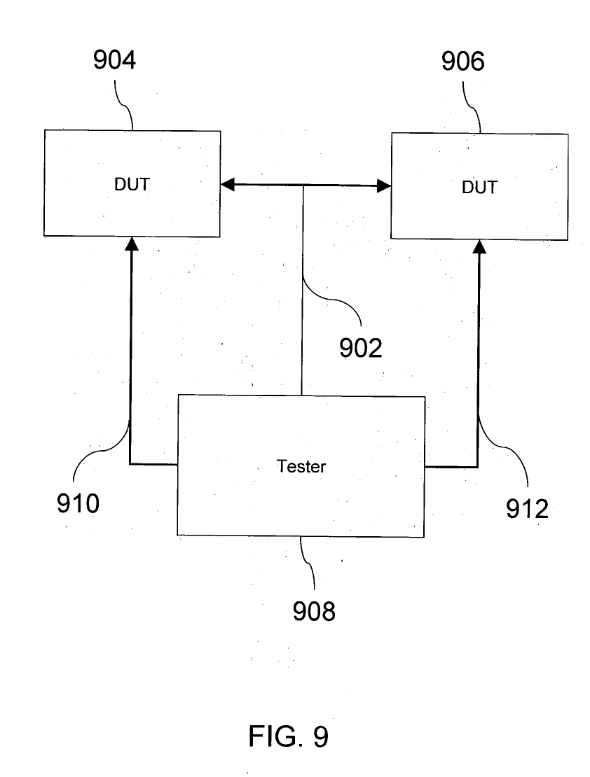

In an alternative embodiment of the invention, the same clock line can be shared between multiple DUTs. FIG. 9 shows an example of such embodiment where a clock line 902 is shared between a DUT 904 and a DUT 906. A tester 908 can test both DUT 904 and DUT 906 concurrently. An I/O line 910 carries the test related data between DUT 904 and tester 908, whereas another I/O line 912 carries test related data between DUT 906 and tester 908. SBS is used to transmit and receive data on both I/O line 910 and I/O line 912. Sharing of a clock line 902 between DUTs 904 and 906 reduces the number of pins on tester 906. This reduces the fixturing complexity and thereby the cost of the test. Also the same tester can test more devices concurrently, as long as either the path skew from the tester to the common clock and all of the DUTs is kept small enough, or the tester is able to measure and correct the timing of the input signal to the DUT correctly.

The invention described above clearly improves upon the disadvantages of the prior art. It reduces the number of pins involved with the testing procedure. Usage of the SBS technique on I/O line 108 dispenses with the need for two different lines for input and output to a particular device. Reduction in pin count also improves the fixturing, and hence reduces overall cost of the test. Usage of SBS also removes timing difficulties involved with IC testing. With simultaneous transmission and reception on I/O line 108, time required for a test is minimized. Moreover, the invention requires only the formation of a transceiver on the DUT 104 chip. This is not a substantial addition to DUT 104 circuit area. Thus, DUT 104 circuit overhead is kept low in the current invention.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A tester device for testing a semiconductor device, the semiconductor device comprising a first transceiver for sending and receiving test related data, the tester device comprising:
a. a clock generator to generate clock signals, the clock signals being sent by the tester device to the semiconductor device;
b. a circuit to produce test related data; and
c. a second transceiver capable of simultaneously transmitting and receiving test related data, the transmission and reception of test related data being synchronized with the clock signals.

2. The tester device as recited in claim 1 wherein the semiconductor device is an integrated circuit.

3. The tester device as recited in claim 1 wherein the test related data comprises:
a. a plurality of test data packets comprising:
i. a stream of test data words;
ii. a test data word count; and
iii. a cyclic redundancy check (CRC) data, the CRC data being capable of detecting errors in the transmission of the test data packet.

4. The tester device as recited in claim 1 wherein the second transceiver comprises:
a. means for transmitting a signal to the semiconductor device;
b. means for receiving a signal at the tester device that has been transmitted by the semiconductor device;
c. means for retransmitting a packet in case there is an error in previous transmission; and
d. means for determining whether the packet received by the tester device has been received correctly.

5. The tester device as recited in claim 4 wherein the means for receiving comprises:
a. means for separating the signal to be driven by the tester device, from the signal received by the tester device; and
b. means for comparing the received signal at the tester device with a predefined reference voltage.

6. The tester device as recited in claim 4 wherein the means for determining comprises:
a. means for maintaining the CRC word; and
b. means for collecting the CRC word.

7. The tester device as recited in claim 4 wherein the means for receiving a signal further comprises:
a. means for imposing a delay in a response signal, the response signal being transmitted by the semiconductor device; and
b. means for strobing the response signal when the response signal is stable.

8. The tester device as recited in claim 7 wherein the means for imposing a delay comprises a series of buffers.

9. A system for testing a semiconductor device with the help of a tester device, the system comprising:
a. a first circuit in the tester device to produce test related data;
b. a clock generator in the tester device to generate clock signals;
c. a first transmission line between the tester device and the semiconductor device, the first transmission line capable of carrying clock signals from the tester device to the semiconductor device, the clock signals being generated by the clock generator;
d. a second transmission line between the tester device and the semiconductor device, the second transmission line capable of carrying test related data between the tester device and the semiconductor device;
e. a first transceiver in the tester device capable of simultaneously transmitting and receiving test related data over the second transmission line, the transmission and reception of test related data being synchronized with the clock signals; and
f. a second transceiver in the semiconductor device, the second transceiver capable of simultaneously transmitting and receiving test related data over the second transmission line, the transmission and reception of test related data being synchronized with the clock signals.

10. The system as recited in claim 9 wherein the semiconductor device is an integrated circuit.

11. The system as recited in claim 9 wherein the first transmission line is shared among a plurality of semiconductor devices being tested by the tester device.

12. A method for testing a semiconductor device with the help of a tester device, the semiconductor device comprising a first transceiver for sending and receiving test related data, the tester device comprising a second transceiver, a test circuit and a clock generator, the method comprising the steps of:
a. connecting a first transmission line between the tester device and the semiconductor device, the first transmission line capable of carrying clock signals from the tester device to the semiconductor device, the clock signals being generated by the clock generator;
b. connecting a second transmission line between the tester device and the semiconductor device, the second transmission line capable of carrying test related data between the tester device and the semiconductor device;
c. synchronizing transmission and reception of test related data by the tester device with the clock signals generated by the clock generator; and
d. simultaneously sending and receiving test related data over the second transmission line between the tester device and the semiconductor device, the transmission and reception of test related data being synchronized with the clock signals.

13. The method as recited in claim 12 wherein the semiconductor device is an integrated circuit.

14. The method as recited in claim 12 wherein the step of simultaneously sending and receiving is implemented with the help of Simultaneous Bidirectional Signaling (SBS) technique.

15. The method as recited in claim 12 wherein the step of synchronizing transmission comprises the steps of:
a. verifying whether proper voltage levels are received and transmitted over the second transmission line;
b. transmitting clock signals continuously over the first transmission line by the clock generator; and
c. providing a timing alignment pattern to the tester device, the timing alignment pattern helping the tester device to determine the most reliable location to check for signals coming from the semiconductor device.

16. The method as recited in claim 15 wherein the step of verifying whether proper voltage levels are received, comprises the steps of:
a. verifying continuity to pins of the semiconductor device connected to the first transmission line and the second transmission line;
b. applying power to the semiconductor device;
c. driving the second transmission line HIGH by the tester device for a predetermined number of clock cycles; and
d. driving the second transmission line LOW by the tester device for a predetermined number of clock cycles.

17. The method as recited in claim 15 wherein the step of providing a timing alignment pattern comprises the step of driving the second transmission line in checkerboard by the semiconductor device for a predetermined number of clock cycles.

18. The method as recited in claim 12 wherein the step of simultaneously sending and receiving test related data comprises the steps of:
a. forming of a test data packet by the tester device;
b. the tester device sending the test data packet to the semiconductor device over the second transmission line;
c. the tester device receiving a response data from the semiconductor device over the second transmission line; and
d. repeating steps a-c for all test data packets to be used in the testing method.

19. The method as recited in claim 18 wherein the step of receiving a response data comprises the step of:
a. receiving an acknowledgement packet signifying whether the test data packet has been received correctly at the end of semiconductor device; and
b. receiving an output packet, the output packet being used to evaluate the performance of the semiconductor device.

20. The method as recited in claim 18 wherein the step of receiving the response data at the tester device further comprises the steps of:
a. delaying the response data obtained from the second transmission line until the response data is stable with respect to the clock signals; and
b. strobing the signal carrying response data when the response data is stable.

21. The method as recited in claim 20 wherein the step of delaying the response data at the tester device comprises the steps of:
a. adding a series of buffers to the second transmission line before the signal carrying response data is received;
b. checking the output of each buffer to determine which buffers are having stable outputs at an edge of the clock signal;
c. identifying four successive buffers having identical stable output; and
d. registering outputs of central two of the four successive buffers in two D-type flip-flops.

22. The method as recited in claim 18 wherein the step of sending the test data packet to the semiconductor device comprises the steps of:
a. maintaining a CRC register;
b. sending the test data packet one data word at a time;
c. keeping a count of the test data words sent; and
d. sending contents of the CRC register, if all the test data words have been sent.
